(19) United States
(12) Patent Application Publication
(10) Pub. No.: US 2002/0096033 A1
(43) Pub. Date: Jul. 25, 2002

(54) Sawing machine adjustable in upper limit of operational space height thereof

(76) Inventor: Jung-Hua Lin, Taichung Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/767,698

(22) Filed: Jan. 24, 2001

(51) Int. Cl. B27B 13/02; B27B 13/08

(52) U.S. Cl. 83/816; 83/699.41; 83/699.61; 83/783

(57) ABSTRACT

A sawing machine comprises a machine stand on which a top seat and a bottom seat are connected by connection mechanism enabling the top seat to move up and down in relation to the bottom seat, so as to accommodate a workpiece in an operational space located between the top seat and the bottom seat.

### FIELD OF THE INVENTION

The present invention relates generally to a sawing machine, such as a belted sawing machine or a linear sawing machine, and more particularly to a sawing machine which can be adjusted in the upper limit of its operational space height.

### BACKGROUND OF THE INVENTION

As shown in FIG. 1, a belted sawing machine of the prior art comprises a machine stand 91 which has a top seat 92 and a bottom seat 93. A connection seat 94 is provided to fasten together the top seat 92 and the bottom seat 93. A work table 95 is disposed on the top of the bottom seat 93 such that an operational space 96 is located over the work table 95. One section of an annular saw strip 97 is put through the operational space 96 via the interiors of the top seat 92 and the bottom seat 93. The saw strip 97 is driven by a drive mechanism (not shown in the drawing) to turn at a high speed to execute the operation of cutting a work piece in the operational space 96.

The conventional linear sawing machine is generally similar in construction to the belted sawing machine 90, except that the former comprises a saw strip which is of a linear construction and is longitudinally mounted between the top seat and the bottom seat. The linear saw strip is driven to move up and down in a reciprocating manner.

Both belted sawing machine and the linear sawing machine are provided with a holding mechanism 98 which is mounted on the top seat 92 for stabilizing the saw blade 97 such that the holding mechanism 98 is moved within the limit of the height of the operational space 96. In light of the height limitation of the operational space 96, only the workpieces of certain sizes can be accommodated in the operational space 96. The top seat can be raised by a pad to raise the top limit of the operational space. However, such a practice involves the disassembling of the machine stand as well as the recalibrating the sawing machine.

### SUMMARY OF THE INVENTION

The primary objective of the present invention is to provide a sawing machine which is free of the design deficiencies of the prior art sawing machines described above.

The present invention comprises a top seat and a bottom seat, which are connected by a connection mechanism in such a manner that the top seat is adjustable to allow the expansion of the operational space of the sawing machine, so as to accommodate a workpiece which can not be otherwise fitted thereinto.

### BRIEF DESCRIPTION OF THE DRAWINGS

FIG. 1 shows a perspective view of a belted sawing machine of the prior art.

FIG. 2 shows a schematic view of the present invention.

FIG. 3 shows a rear view of the present invention.

FIG. 4 shows a right view of the present invention.

FIG. 5 shows a top view of the present invention.

FIG. 6 shows a sectional view taken along the direction indicated by a line 6-6 as shown in FIG. 2.

FIG. 7 shows a sectional view taken along the direction indicated by a line 7-7 as shown in FIG. 6.

FIG. 8 shows a schematic view of the present invention at work.

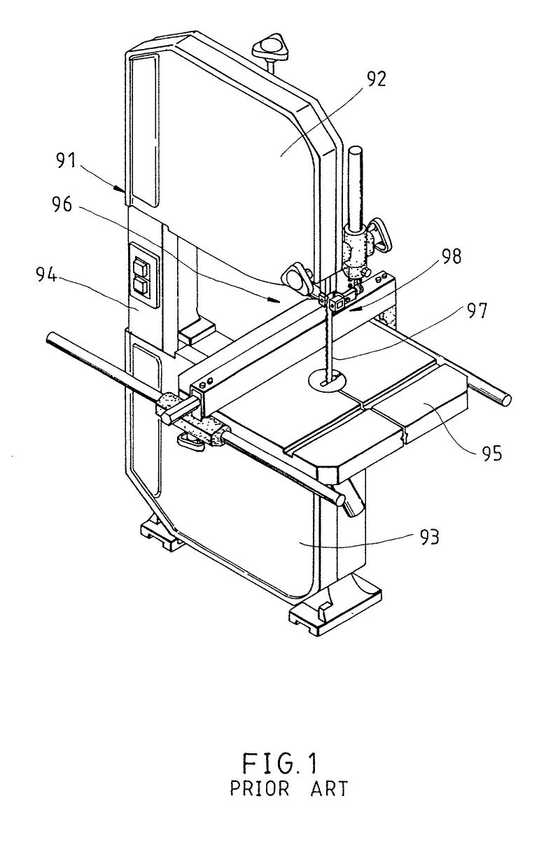

### DETAILED DESCRIPTION OF THE INVENTION

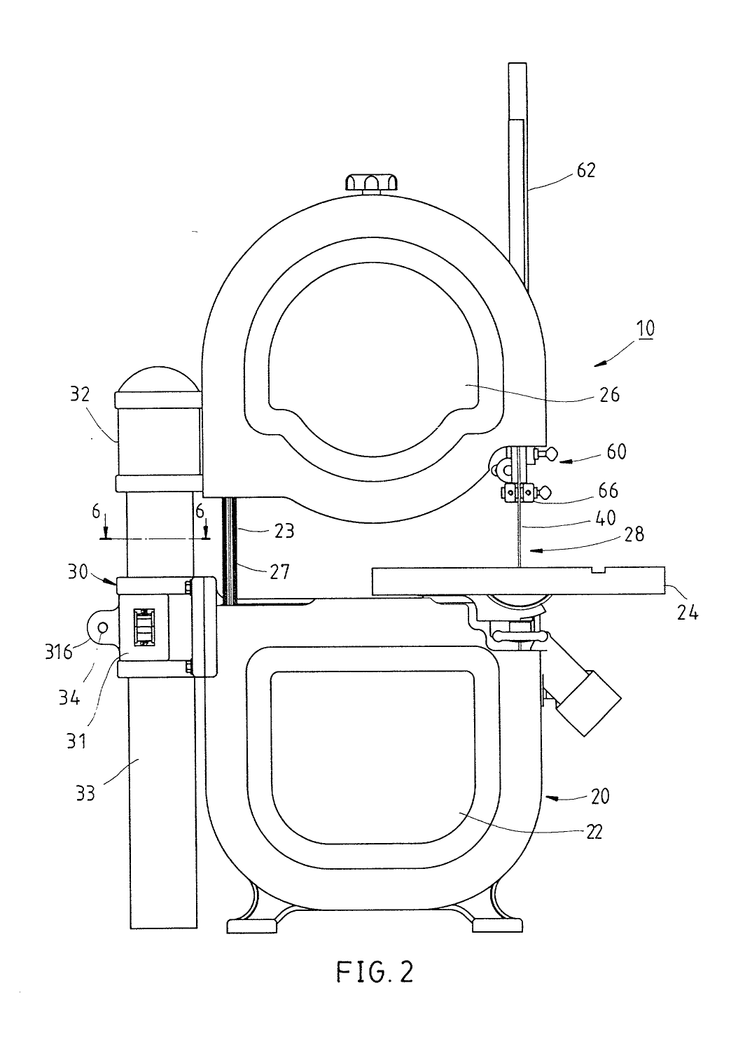

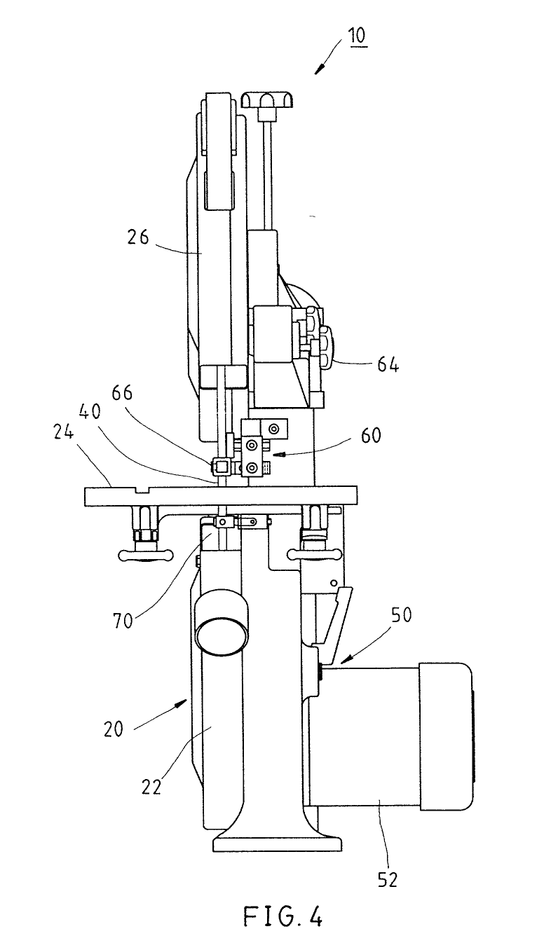

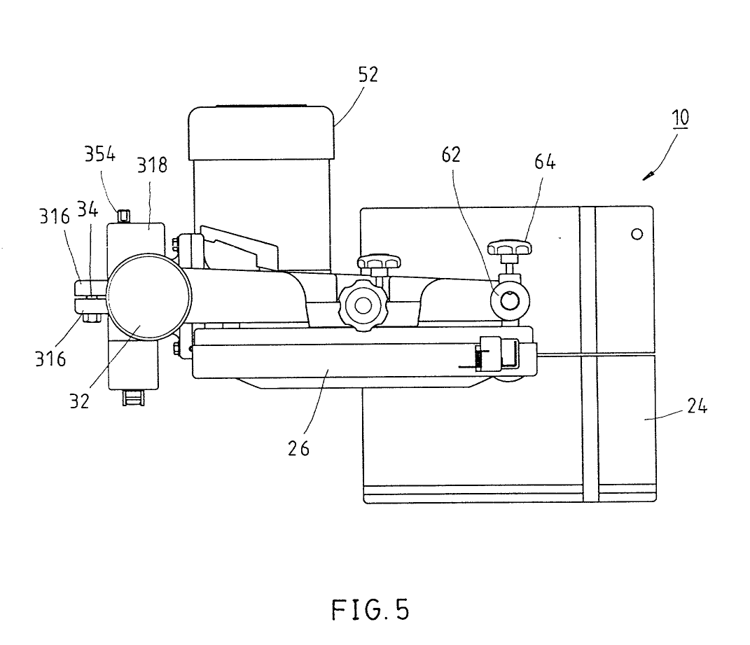

As shown in FIGS. 2-5, a belted sawing machine 10 embodied in the present invention comprises the component parts which are described hereinafter.

A machine stand 20 has a bottom seat 22, which is provided thereon which a work table 24 for placing a workpiece. Located over the bottom seat 22 is a top seat 26, which is connected with the bottom seat 22 by a connection mechanism 30 such that an operational space 28 is formed in the right side portion between the bottom seat 22 and the top seat 26. In other words, the operational space 28 is located over the work table 24.

A circular saw strip 40 is mounted on the machine stand 20 such that the circular saw strip 40 runs through the round wheels located in the interiors of the top seat 26 and the bottom seat 22, and that a section of the saw strip 40 running through the right side of the operational space 28 is located at the center of the work table 24 for executing the sawing of the workpiece.

A drive mechanism 50 is mounted on the bottom seat 22 of the machine stand 20 and is formed of a motor 52 and a transmission variable speed device (not shown in the drawing). The round wheels referred to above are parts of the transmission variable speed device. The saw strip 40 is driven by the transmission variable speed device to turn at a high speed such that the section of the saw strip 40 is engaged in a unidirectional linear motion by means of which the workpiece is cut.

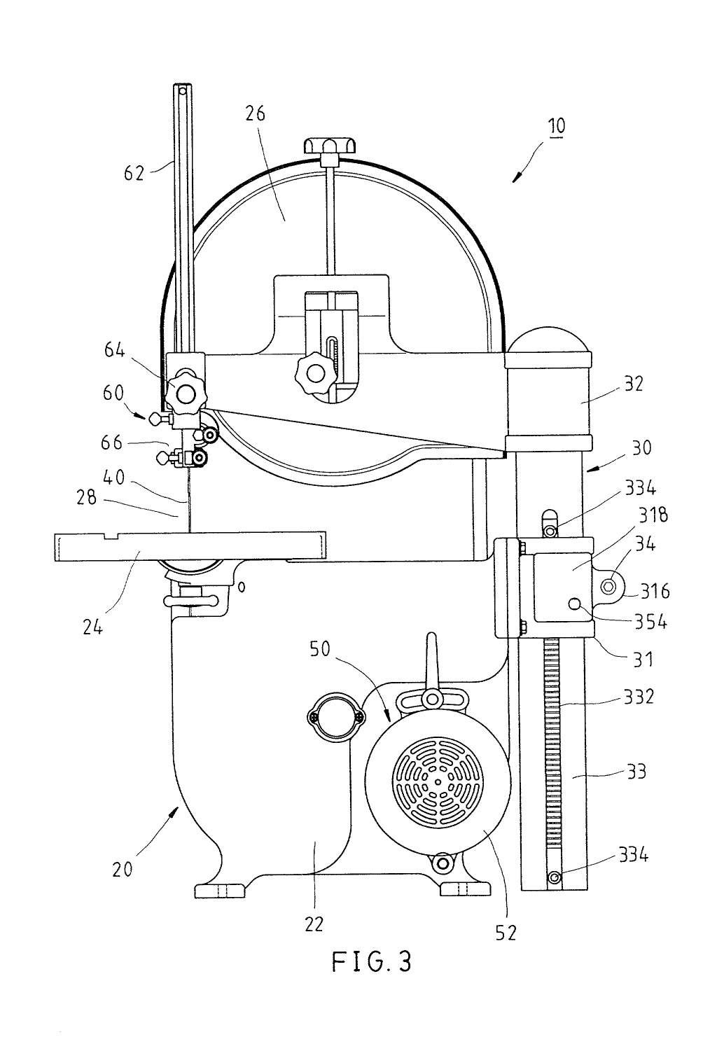

Two holding mechanisms 60 and 70 are mounted in such a way that they are respectively corresponding in location to the top end and the bottom end of the section of the saw strip 40, with the first holding mechanism 60 being mounted at the top end. The first holding mechanism 60 has a slide pillar 62 which is longitudinally pivoted with the top seat 26 and is capable of sliding up and down. The slide pillar 62 can be located by a fastening bolt 64 and is provided at the bottom end with a holding member 66 for holding two sides of the saw strip 40. The second holding mechanism 70 is mounted at the bottom of the work table 24, as shown in FIG. 3, for securing the saw strip 40. In accordance with the height of a workpiece, the holding point of the first holding mechanism 60 is so adjusted as to locate in proximity of the top of the workpiece, thereby enabling the first holding mechanism 60 and the second holding mechanism 70 to work together to stabilize the saw strip 40 in operation.

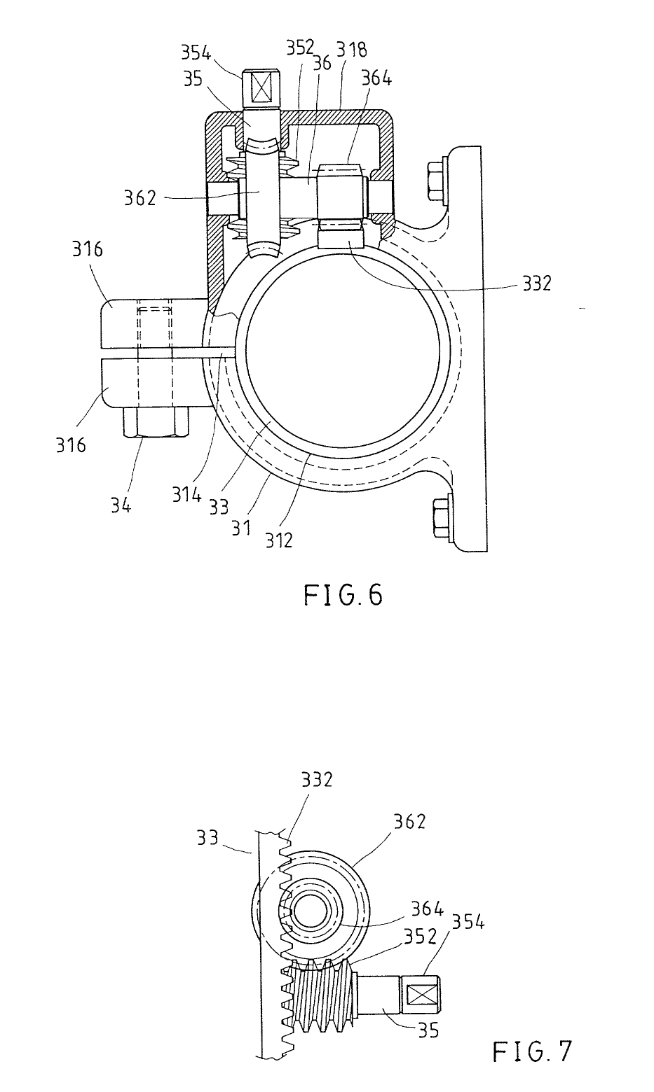

The present invention is characterized by the top seat 26 of the machine stand 20, which can be adjusted upward or downward, thanks to the connection mechanism 30. As shown in FIGS. 6 and 7, the connection mechanism 30 comprises a carrying seat 31, which is mounted on the top of the left side of the bottom seat 22 and is provided at the center with a pivoting through hole 312. A rod seat 32 is disposed at the bottom of the left side of the top seat 26 and is provided with a connection rod 33 fastened therewith. The connection rod 33 is put through the pivoting through hole 312. The carrying seat 31 is provided with a slit 314 extending along the axial direction thereof. The slit 314 is provided in two sides thereof with a protruded block 316. The two protruded blocks 316 are provided with an adjusting bolt 34 fastened therebetween for adjusting the inner diameter of the pivoting through hole 312 such that the outer wall of the connection rod 33 is in an intimate contact with the inner wall of the pivoting through hole 312. The carrying seat 31 is provided in the back side with a shell box 318. The connection rod 33 is provided in the back side with a rack 332, which is corresponding in location to the section of the carrying seat 31 and is located in the shell box 318. A drive shaft 35 is horizontally pivoted to the rear wall of the shell box 318 such that the front end of the drive shaft 35 is located in the shell box 318 and is provided with a worm rod 352. The rear end of the drive shaft 35 is located in the outside of the shell box 318 and is provided with a connection head 354. A driven shaft 36 is horizontally pivoted in the shell box 318 such that the driven shaft 36 is perpendicular to the drive shaft 35. The driven shaft 36 is provided with a worm wheel 362 and a gear 364. The worm wheel 362 is engaged with the worm rod 352 of the drive shaft 35. The gear 364 is meshed with the rack 332 of the connection rod 33.

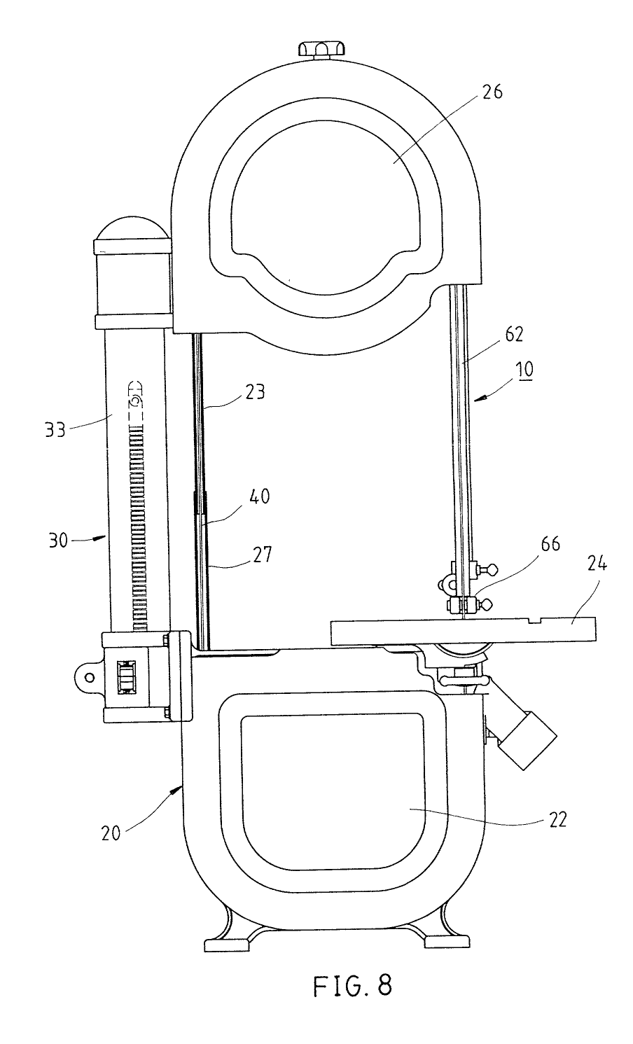

A crank handlebar is fitted into the connection head 354 of the drive shaft 35. As the handlebar is turned to actuate the drive shaft 35 to drive the driven shaft 36 via the worm wheel 362 of the worm rod 352. The connection rod 33 is then actuated by the driven shaft 36 to displace axially via the rack 332 of the gear 364, thereby resulting in the upward or the downward displacement of the top seat 26. The main shaft 35 may be driven by a small motor in conjunction with a control circuit. The connection rod 33 is provided at the upper end and the lower end of the rack 332 with a retaining projection 334 capable of retaining the carrying seat 31, as shown in FIG. 3. The up-and-down displacement range of the connection rod 33 can be thus set. The top seat 26 is located at the lowest point of the range, as shown in FIG. 3, and at the highest point of the range, as shown in FIG. 8. The top seat 26 is secured in place by the adjustment bolt 34 which enables the carrying seat 31 to secure the connection rod 33.

As shown in FIGS. 2 and 8, the sawing machine 10 is provided with an inner protective frame 27 and an outer protective frame 23. As the top seat 26 is raised, these two protective frames shield the section of the saw strip 40. As the top seat 26 is lowered, these two protective frames are fitted together such that the tail end is partially extended into the interior of the bottom seat 22 or the top seat 26.

What is claimed is:

1. A sawing machine comprising:
a machine stand having a top seat, a bottom seat, and a connection mechanism connecting said top seat with said bottom seat, thereby resulting in formation of an operational space between said top seat and said bottom seat whereby said connection mechanism enables said top seat to move up and down such that said top seat is located at a level;
a saw strip mounted on said machine stand such that said saw strip is put through said operational space; and
a drive mechanism mounted on said machine stand to drive said saw strip to move linearly in said operational space.

2. The sawing machine as defined in claim 1, wherein said connection mechanism comprises a rod seat, a carrying seat, and a connection rod, said carrying seat provided with a pivoting through hole in which said connection rod is pivoted such that said connection rod is capable of sliding in relation to said carrying seat, thereby causing said top seat to slide up and down in relation to said bottom seat.

3. The sawing machine as defined in claim 2, wherein said carrying seat has a slit extending along to axial direction of said pivoting through hole, and two protruded blocks, with each being located at the side of said slit, said two protruded blocks being provided with an adjustment bolt fastened therebetween for adjusting the inner diameter of said pivoting through hole.

4. The sawing machine as defined in claim 2, wherein said connection rod is provided at one side with a rack; wherein said carrying seat is provided with a gear pivoted thereto such that said gear is engaged with said rack whereby said gear drives said connection rod and said carrying seat to displace.

5. The sawing machine as defined in claim 4, wherein said rack is provided at both ends thereof with a retaining projection.

6. The sawing machine as defined in claim 4, wherein said carrying seat is provided with a drive shaft pivoted thereto, and a driven shaft pivoted thereto such that said driven shaft is perpendicular to said drive shaft, said drive shaft and said driven shaft being provided with a worm rod and a worm wheel engaging said worm rod; wherein said gear is mounted on said driven shaft.

7. The sawing machine as defined in claim 6, wherein said drive shaft is provided at one end with a connection head for fitting a manually-operated handlebar.

8. The sawing machine as defined in claim 6, wherein said drive shat is driven by a motor in conjunction with a control circuit.

9. The sawing machine as defined in claim 1, wherein said saw strip is of a circular construction and is provided with a section is proximity of said connection mechanism whereby said section is put through a space between said top seat and said bottom seat; wherein said top seat and said bottom seat are provided with a protective frame for shielding said section of said saw strip whereby said two protective frames can be fitted together.
